(19) United States
(12) Patent Application Publication
(10) Pub. No.: US 2009/0130548 A1
(43) Pub. Date: May 21, 2009

(54) ELECTRODE ASSEMBLY AND SECONDARY BATTERY USING THE SAME

(75) Inventor: Jang-Ho Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/175,579

(22) Filed: Jul. 18, 2008

(30) Foreign Application Priority Data
Nov. 19, 2007 (KR) 2007-117738

(51) Int. Cl. H01M 2/26

(52) U.S. Cl. 429/161

(57) ABSTRACT

An electrode assembly comprises a positive electrode plate having a positive electrode collector and a positive electrode coating portion formed one the positive electrode collector, a negative electrode plate having a negative electrode collector and a negative electrode coating portion formed on the negative electrode collector; and a separator. Either the positive electrode coating portion or the negative electrode coating portion is divided into a coating-starting portion, a coating-finishing portion and a uniform region between the coating-starting portion and the coating-finishing portion.

### CROSS-REFERENCE TO RELATED APPLICATIONS

This application claims the benefit of Korean Application No. 2007-117738, filed Nov. 19, 2007, the disclosure of which is hereby incorporated herein by reference.

### BACKGROUND OF THE INVENTION

1. Field of the Invention

Aspects of the present invention relate to an electrode assembly and secondary battery using the same for preventing damage to a separator and implementing a uniform jelly-roll shape of-the electrode assembly.

2. Description of the Related Art

Recently, compact and light electric/electronic devices, such as portable phones, notebook computers, camcorders, etc., have been developed and manufactured. Such portable electric/electronic devices include a battery pack that serves as a driving electric power for the device in places where electric power is not generally provided. The battery pack includes at least one battery that drives the portable electric/electronic devices for a certain period of time by outputting a constant voltage level. Secondary batteries have recently been used as the battery in such battery packs because of practicality, economic efficiency, easy recharging, smaller size and larger capacity. Among secondary batteries, lithium secondary batteries have been widely used because the operating voltage of 3.6 volt of the lithium secondary battery is three times as high as that of a Ni—Cd battery or a Ni—MH battery, which have been widely used for portable electric/electronic electric power, and the energy density per unit weight is also high.

The lithium secondary battery comprises an electrode assembly having a positive electrode plate, a negative electrode plate and a separator, and a casing accommodating the electrode assembly. Generally, each electrode plate is formed by coating a slurry having electrode active materials onto one surface of an electrode collector, which is made of metal foil. The positive electrode plate, the negative electrode plate and the separator, which are each formed as a strip, are disposed so that the separator is between the negative electrode plate and the positive electrode plate, and an electrode assembly having a jelly roll configuration is formed by a winding process.

On the surface of the electrode collector, an electrode coating portion of an electrode plate is formed by coating the slurry on a region corresponding to the desired length for forming an electrode. A non-coated portion of the electrode plate, which is a region on which the electrode active materials are not coated, is used for welding an electrode tab to the electrode plate. In a process of coating an electrode active material slurry onto an electrode collector, the slurry typically forms a hard mass (protrusion) at the starting portion of the coating, and the coating becomes progressively thinner as the coating proceeds along a length of an electrode collector due to a phenomenon of hauling.

In forming an electrode assembly, a separator is inserted between the electrode plates formed as above, and a jelly-roll type electrode assembly is made by winding the electrode plates and separator using a mandrel. In the conventional electrode assembly, the protrusion created at the starting portion of each electrode plate due to the coating process causes a problem of a non-uniform shape of the jelly-roll, since the portion of the electrode plate including the protrusion is distorted while the positive electrode plate, negative electrode plate and separator are wound by using a mandrel. Further, the conventional electrode assembly is bulky because of the protrusion. Further, the protrusion may cause damage to the separator insulating both the positive and negative electrode plates by applying pressure during processing. If damaged, the separator may cause an internal shortage between the positive and negative electrode plates, thereby lowering battery production yield and causing safety accidents.

### SUMMARY OF THE INVENTION

Aspects of the present invention provide an electrode assembly and secondary battery using the same that prevents damage to a separator and implementing a uniform shape of jelly-roll structure of the electrode assembly.

According to an embodiment of the present invention, an electrode assembly may comprise a positive electrode plate having a positive electrode collector and a positive electrode coating portion formed on the positive electrode collector, a negative electrode plate having a negative electrode collector and a negative electrode coating portion formed on the negative electrode collector, and a separator. Either the positive electrode coating portion or the negative electrode coating portion may be divided into a coating-starting portion, a coating-finishing portion and a uniform region between the coating-starting portion and the coating-finishing portion. The electrode assembly has a jelly-roll structure and the coating-finishing portion is disposed at a center of the jelly-roll structure.

According to an aspect of the present invention, the coating-starting portion may be thicker than the uniform region, and the coating-finishing portion may be thinner than the uniform region.

According to an aspect of the present invention, the positive electrode coating portion is formed on both sides of the positive electrode collector and the negative electrode coating portion is formed on both sides of the negative electrode collector.

According to an aspect of the present invention, a direction from the coating-starting portion to the coating-finishing portion of the positive electrode coating portion is the same on both sides of the positive electrode collector and a direction from the coating-starting portion to the coating-finishing portion of the negative electrode coating portion is the same on both sides of the negative electrode collector.

According to an aspect of the present invention, the positive and negative electrode plates may respectively comprise a positive electrode non-coating portion on which a positive electrode tab is connected and a negative electrode non-coating portion on which a negative electrode tab is connected.

According to an aspect of the present invention, the positive electrode plate and the negative electrode plate may respectively comprise an insulating member covering either the coating-starting portion or the coating-finishing portion.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is an exploded perspective view of an electrode assembly according to an embodiment of the present invention;

FIG. 1B is a front view of the electrode assembly of FIG. 1A;

FIG. 2 is a plane view illustrating a method of forming electrode plate according to an embodiment of the present invention;

FIG. 3 is a plane view illustrating an initial winding portion in a method of forming an electrode assembly according to an embodiment of the present invention; and

FIG. 4 is a plane view illustrating an electrode assembly in a wound state according to an embodiment of the present invention;

FIG. 5 is an exploded perspective view illustrating a pouch type secondary battery having the electrode assembly according to an embodiment of the present invention.

FIG. 6 is an exploded perspective view illustrating a can type secondary battery having the electrode assembly according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

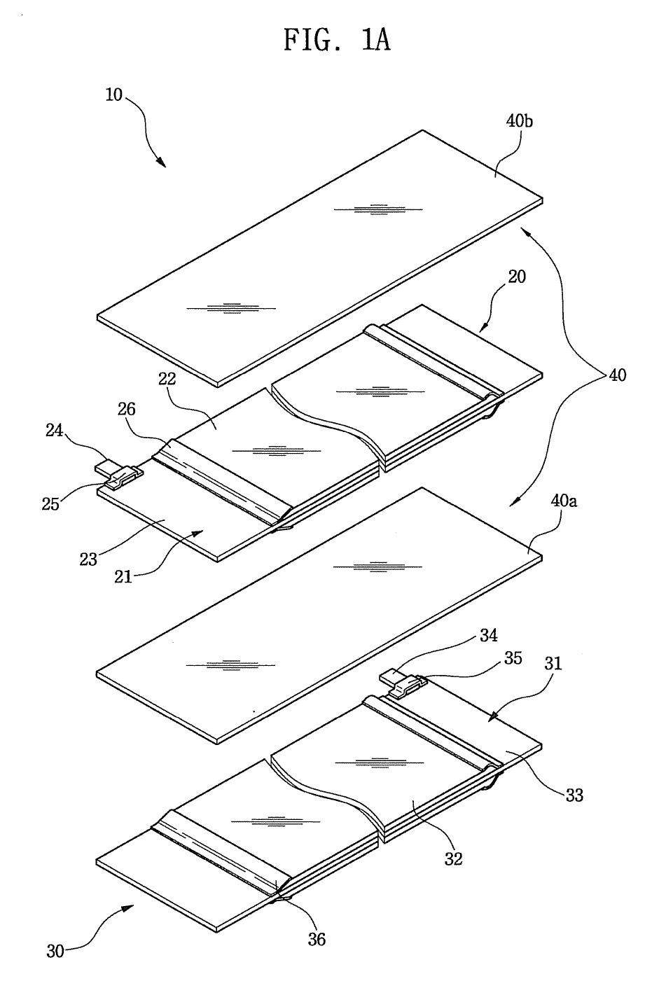

FIG. 1A is an exploded perspective view of an electrode assembly according to an embodiment of the present invention, and FIG. 1B is a front view of the electrode assembly of FIG. 1A. Referring to FIGS. 1A and 1B, an electrode assembly 10 comprises a first electrode plate 20 (positive electrode plate), a second electrode plate 30 (negative electrode plate), and a separator 40. The electrode assembly 10 may be formed in a jelly-roll shape in which the positive electrode plate 20, the negative electrode plate 30, and a separator 40 are stacked and wound.

The separator 40 comprises a first separator section 40a disposed between the positive electrode plate 20 and the negative electrode plate 30, and a second separator section 40b disposed below or over the positive and negative electrode plates 20 and 30. The separator 40 prevents shortage between the positive and negative electrode plates 20 and 30 by interposing into a contacting portion of the positive and negative electrode plates 20 and 30.

The positive electrode plate 20 comprises a positive electrode collector 21 that collects electrons generated by chemical reaction and delivers the electrons to external circuitry, and a positive electrode coating portion 22 comprising a positive electrode slurry having positive electrode active materials coated on one or both surfaces of the positive electrode collector 21.

The positive electrode coating portion 22 may be divided into non-uniform regions having a starting portion of the positive electrode coating portion 22a and a finishing portion of the positive electrode coating portion 22b which are located at opposite ends of the positive electrode coating portion 22, and a uniform region 22c formed between the non-uniform regions. The starting portion 22a of the positive electrode coating portion is the portion where the slurry coating process is started in forming the positive electrode coating portion and where the protrusion described above is formed. The finishing portion 22b is the portion where the slurry coating process is completed. Because of a phenomenon of hauling, the slurry is less coated at the finishing portion 22b, compared with uniform region 22c and the starting portion 22a. In other words, the starting portion 22a of the positive electrode coating portion 22 is thicker than the uniform region 22c, and the finishing portion 22b of the positive electrode coating portion 22 is thinner than the uniform region 22c.

The positive electrode coating portion 22 may be formed on one side or both sides of the positive electrode collector 21, as illustrated in FIG. 1B. When the positive electrode coating portion 22 is formed on both sides of the positive electrode collector 21, the starting portions 22a and finishing portions 22b on both sides of the positive electrode collector 21 have the same orientation with respect to the positive electrode collector 21. In other words, the starting portions 22a on both sides of the positive electrode collector 21 are at one end of the positive electrode collector 21 and the finishing portions 22b on both sides of the positive electrode coating portion 22 are at the other end of the positive electrode collector 21.

Moreover, the positive electrode plate 20 includes a non-coated portion 23 where the positive electrode slurry is not coated on the positive electrode collector 21. The non-coated portion 23 may exist at one or both ends of the positive electrode collector 21.

The positive electrode collector 21 may be formed of stainless steel, nickel, aluminum, titanium, an alloy of these materials, or a material in which carbon, nickel, titanium or silver is applied by surface-treating on either aluminum or stainless steel. Of these materials, aluminum or aluminum alloy is preferable, but the material of the positive electrode collector 21 is not limited thereto.

The positive electrode collector 21 may be in the form of a foil, film, sheet, a punched material, a porous object, or a material formed by a blowing agent, etc. The thickness of the positive electrode collector 21 may be about 1˜50 μm, preferably 1˜30 μm. The shape and thickness is not limited thereto.

The positive electrode coating portion 22 may comprise electro-conductive materials such as carbon black or graphite powder and positive electrode active materials mixed with a binder.

As non-limiting examples, the positive electrode active material may include at least one selected from cobalt, manganese and nickel or one or more compound oxides with lithium. The positive electrode active material is not limited thereto.

A positive electrode tab 24 that delivers the electrons collected in the positive electrode collector 21 to external circuitry is connected to the positive electrode non-coated portion 23. The positive electrode tab 24 is formed in a thin film of either nickel or aluminum material.

A protection member 25 may be formed on a joining portion to which the positive electrode tab 24 is connected. The protection member 25 may be made of a material having thermal resistance, such as, for example, a high molecule resin such as polyester, for preventing short circuits by protecting the joining portion. Further, the protection member 25 may have enough width and length to completely wrap the positive electrode tab 24 connecting to the positive electrode non-coated portion 23.

Further, the positive electrode plate 20 may comprise at least one insulating member 26 for covering at least one the ends of the positive electrode coating portion 22. The insulating member 26 may be formed as an insulating tape comprising an adhesive layer and an insulating film attached on a surface of the adhesive layer. The shape and material of the insulating member 26 is not limited thereto. As non-limiting examples, the adhesive layer, for example, may be formed of an ethylene-acrylic ester copolymer, a rubber-based adhesive, an ethylene acetate-vinyl copolymer, or similar materials. The insulating film may be formed of polypropylene, polyethylene terephthalate or polyethylene naphthalene, or similar materials.

The negative electrode plate 30 comprises a negative electrode collector 31 that collects electrons generated by chemical reaction and delivers the electrons to external circuitry, and a negative electrode coating portion 32 comprising a negative electrode slurry having negative electrode active materials coated on one or both surfaces of the negative electrode collector 31.

The negative electrode coating portion 32 may be divided into non-uniform regions having a starting portion of the negative electrode coating portion 32a and a finishing portion of the negative electrode coating portion 32b which are located at opposite ends of the negative electrode coating portion 32, and a uniform region 32c formed between the non-uniform regions. On the starting portion 32a of the negative electrode collector 32, where the slurry coating process is started in forming the negative electrode coating portion 32, the slurry forms a protrusion region that is thicker than the uniform portion 32c of the negative electrode coating portion 32. Moreover, the slurry is coated more thinly on a finishing portion 32b of the negative electrode coating portion 32, where the slurry coating process is completed, due to a phenomenon of hauling. In other words, the starting portion of the negative electrode coating portion 32a is thicker than the uniform region 32c, and the finishing portion of the negative electrode coating portion 32b is thinner than the uniform region 32c.

The negative electrode coating portion 32 may be formed on one side or both sides of the negative electrode collector 31. When the negative electrode coating portion 32 is formed on both sides of the negative electrode collector 31, the starting portions 32a and the finishing portions 32b on both sides of the negative electrode collector 31 have the same orientation with respect to the negative electrode collector 31. In other words, the starting portions 32a on both sides of the negative electrode collector 31 are at one end of the negative electrode collector 31 and the finishing portions 32b on both sides of the negative electrode coating portion 32 are at the other end of the positive electrode collector 31.

Moreover, the negative electrode plate 30 includes a non-coated portion 33 where the negative slurry is not coated on the negative electrode collector 31. The non-coated portion 33 may be at one side or both ends of the negative electrode collector 31.

The negative electrode collector 31 may be formed of stainless steel, nickel, aluminum, titanium, an alloy of these materials, or a material in which carbon, nickel, titanium or silver is applied by surface-treating on either aluminum or stainless steel. Of these materials, aluminum or aluminum alloy is preferable, but the material of the negative collector 31 is not limited thereto.

The negative electrode collector 31 may be in the form of a foil, film, sheet, a punched material, a porous object or material formed by a blowing agent, etc. The thickness of the negative electrode collector 31 may be about 1˜50 μm, preferably 1˜30 μm. The shape and thickness is not limited thereto.

The negative electrode coating portion 32 may comprise electro-conductive materials such as carbon black or graphite powder and negative electrode active materials mixed with a binder. The binder may be polyvinylidene fluoride (PVDF), styrene butadiene rubber (SBR) or polytetrafluoro ethylene (PTFE), etc.

Carbon materials, such as crystalline carbon, amorphous carbon, carbon mixture and carbon fiber, etc, lithium metal or lithium alloy, may used as the negative electrode active material. The composition of the negative electrode active materials is not limited thereto.

A negative electrode tab 34 that delivers the electrons collected in the negative electrode collector 31 to external circuitry is connected to the negative electrode non-coated portion 33. The negative electrode tab 34 may be formed in a thin film of nickel material.

A protection member 35 may be formed on a joining portion to which the negative electrode tab 34 is connected. The protection unit 35 may be made of a material having thermal resistance, such as, for example, a high molecule resin such as polyester, for preventing short circuits by protecting the connecting portion. Further, the protection member 35 may have enough width and length to completely wrap the negative electrode tab 34 connecting to the negative electrode non-coated portion 33.

Moreover, the negative electrode plate 30 may comprise at least one insulating member 36 that covers at least one of the ends of the negative electrode coating portion 32. The insulating member 36 may be formed as an insulating tape comprising an adhesive layer and an insulating film attached on a surface of the insulating layer. The shape and material of the insulating member 36 is not limited thereto. The adhesive layer, for example, may be formed of an ethylene-acrylic ester copolymer, a rubber-based adhesive, an ethylene acetate-vinyl copolymer, or similar materials. The insulating film may be formed as polypropylene, polyethylene terephthalate or polyethylene naphthalene, or similar materials.

Five positive electrode plates and five negative electrode plates were formed according to aspects of the present invention and the thickness of the coating portion of the electrode plates was measured. Table 1 is a graph showing the thickness measured at the starting-portion, the uniform region and the finishing-portion of both positive and negative electrode coating portions of the positive electrode plates and the negative electrode plates.

| | Positive electrode | | | Negative electrode | | |
|---|---|---|---|---|---|---|
| | coating portion(μm) | | | coating portion(μm) | | |
| | Starting | Uniform | Finishing | Starting | Uniform | Finishing |
| | Portion | Region | Portion | Portion | Region | Portion |
| 1 | 72 | 70 | 69 | 73 | 72 | 64 |
| 2 | 73 | 70 | 69 | 73 | 72 | 65 |
| 3 | 72 | 70 | 69 | 72 | 71 | 65 |
| 4 | 72 | 70 | 68 | 73 | 72 | 65 |
| 5 | 73 | 71 | 68 | 72 | 71 | 64 |

As shown in Table 1, both the positive and negative electrode coating portions are more thickly formed at the starting-portion, the uniform region and less thickly formed at the finishing-portion.

The separator 40 may comprise a thermal-resistant resin such as polyethylene or polypropylene. The surface of the separator 40 may have a porous membrane structure.

As a safety feature, the porous membrane structure may become an insulating film when pores of the separator 40 are closed off by melting, such as when the internal temperature of the battery rises to the melting point of the thermal-resistant resin. When the separator 40 is converted to an insulating film, the movement of the lithium ions between the positive electrode plate 20 and the negative electrode plate 30 may be blocked, and the internal temperature of the battery may not rise up any more due to no current-flow.

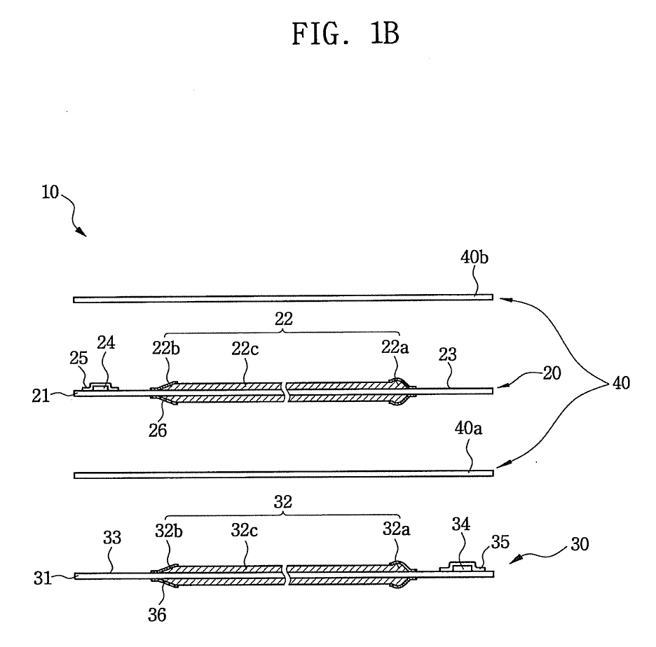

FIG. 2 schematically illustrates a method of forming electrode plates, as a non-limiting example. An electrode collector 120 wound on a winding/unwinding unit 110 may be conveyed by a first set of moving rollers 130. The electrode collector 120 conveyed by the first set of moving rollers 130 passes through a spot where a first slit-die 135 is located, which coats the first surface of the electrode collector 120 with a slurry containing an active material. A first coating portion 140 is formed on a first surface of the electrode collector 120 disposed toward a top position of the electrode collector 120. The first coating portion 140 comprises a protrusion at a starting portion 141 of the deposition of the slurry due to an excess of slurry being deposited at that point. Further, the first coating portion 140 includes a finishing portion 145 where the slurry coating is completed. The finishing portion 145 has a lesser thickness than the starting portion 141 due to a phenomenon of hauling. A uniform region 143 in which the slurry is uniformly coated is formed between the starting portion 141 and the finishing portion 145.

The electrode collector 120, on which the first coating portion 140 is formed, is conveyed by a second set of moving rollers 150, and is inverted such that a second surface of the electrode collector 120 on an opposite side from the first surface of the electrode collector 120 is in a top position. The electrode collector 120 conveyed by the second set of moving rollers 150 passes through a spot where a second slit-die 160 is located, which coats the second surface of the electrode collector 120 with a slurry containing an active material to form a second coating portion 170 on the second surface of the electrode collector 120. As with the first coating portion 140, the second coating portion 170 forms a protrusion around a starting portion 171 and has a finishing portion 175 where the slurry coating has a lesser thickness due to a phenomenon of hauling and a uniform region 173 between the starting portion 171 and the finishing portion 175 where the slurry is uniformly coated.

The electrode collector 120 that has the first and second coating portions 140 and 170 formed thereof is conveyed by a third set of moving rollers 180 and is wound by a winding/unwinding unit 190 after passing through a dryer.

Accordingly, both the first and second coating portions 140 and 170 formed on the electrode collector 120 are coated in a same position on opposite surfaces of the electrode collector 120 such that the starting portions 141 and 171 of the first and second coating portions 140 and 170 are opposite each other and the finishing portions 145 and 175 of the first and second coating portions 140 and 170 are opposite each other.

The method of forming an electrode plate is not limited to what is described above and may be variously implemented by those skilled in the art.

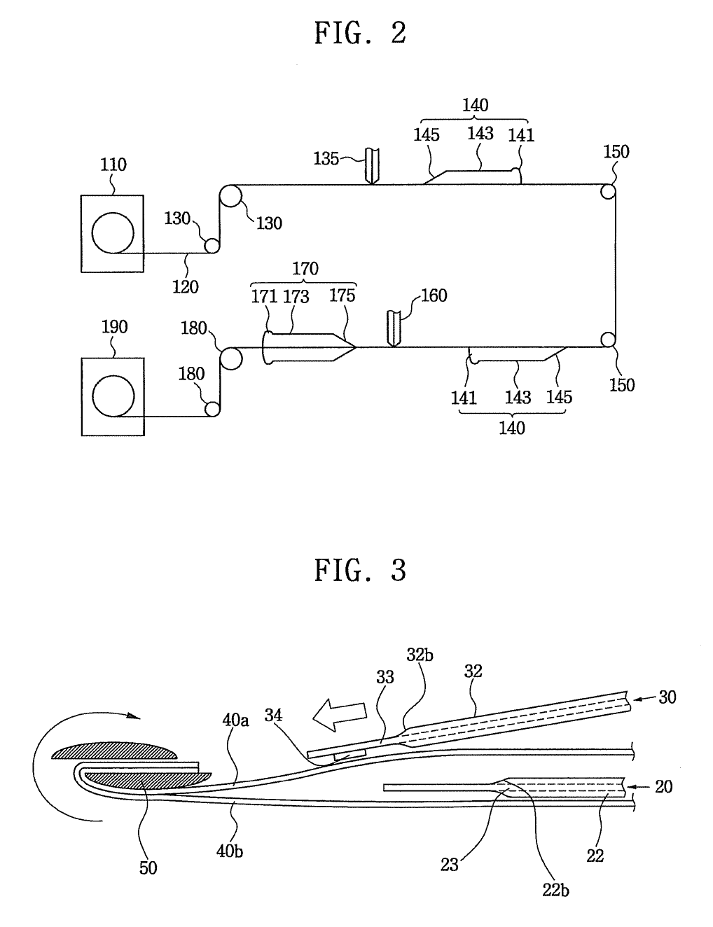

FIG. 3 is a plane view illustrating an initial winding portion in a method of forming an electrode assembly according to an embodiment of the present invention. Referring to FIG. 3, predetermined lengths of the first and second separators 40a and 40b are wound by a semi-circle type mandrel 50. A positive electrode plate 20 is disposed between the first separator section 40a and the second separator section 40b as the winding proceeds. The non-coated portion 23 of the positive electrode plate 20 is positioned to face the mandrel 50. Meanwhile, the negative electrode plate 30 is disposed at an external side of the first separator section 40a. Further, a negative non-coated portion 33 of the negative electrode plate 30 is positioned to face the mandrel 50. Then the positive and negative electrode plates 20 and 30 may be wound with both the first and second separator sections 40a and 40b. In particular, the positive and negative electrode plates 20 and 30 are positioned such that ends of the positive and negative electrode coating portions 22 and 32 having the finishing portions 22b and 32b are closest to the mandrel 50. Accordingly, the finishing portions 22b and 32b of the positive and negative electrode coating portions 22 and 32 are disposed near the center as the electrode assembly is wound.

The method of forming the electrode assembly is not limited thereto, and may be variously implemented by those skilled in the art.

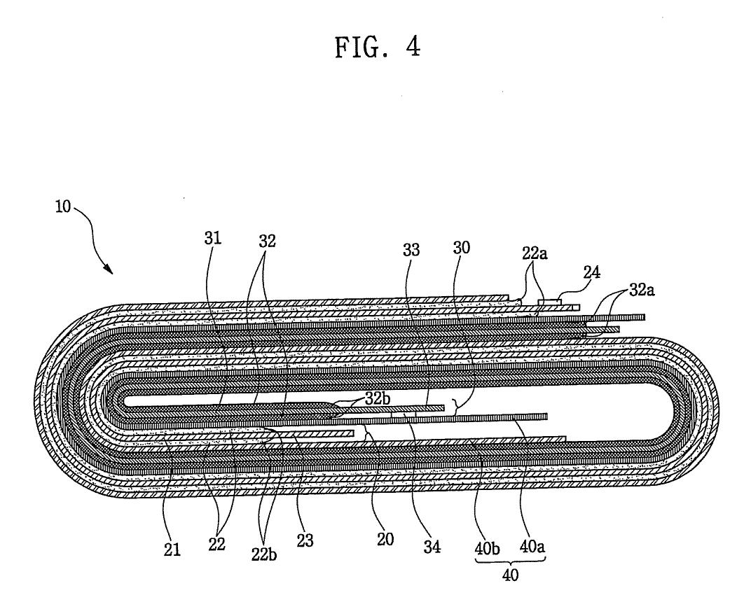

FIG. 4 is a plane view showing an electrode assembly 10 according to an embodiment in a wound state. The electrode assembly 10 is formed by stacking and winding a negative electrode plate 30, a first separator section 40a, a positive electrode plate 20 and a second separator section 40b one after the other.

Both the negative electrode non-coated portion 33 adjacent to the finishing portion 32b of the negative electrode coated portion 32 of the negative electrode plate 30 and the positive electrode non-coated portion 23 adjacent to the finishing portion 22b of the positive electrode coated portion 22 of the positive electrode plate 20 are disposed at the center of the electrode assembly 10. Further, the first separator section 40a is interposed between the negative electrode non-coated portion 33 and the positive electrode non-coated portion 23 so as to insulate the negative electrode non-coated portion 33 and the positive electrode non-coated portion 23. Further, both sections 40a and 40b of the separator 40 should have enough length to completely insulate the positive electrode plate 20 and the negative electrode plate 30.

A positive electrode tab 24 is joined to the positive electrode non-coated portion 23 adjacent to the starting portion 22a of the positive electrode coated portion 22, and a negative electrode tab 34 is joined to the negative non-coated portion 33 adjacent to the finishing portion 32b of the negative electrode coated portion 32. With this arrangement, the positive electrode tab 24 is positioned near the outermost part of the electrode assembly 10 and the negative electrode tab 34 is positioned near the innermost part of the electrode assembly 10. However, the electrode assembly is not limited to this embodiment.

Since the electrode assembly 10 is wound starting at the end of electrode plates 20 and 30 having the finishing portions 22b and 32b of the positive and negative electrode coating portions 22 and 32, the finishing portions 22b and 32b are disposed at the center of the wound electrode assembly 10 and the starting portions 22a and 32a of the positive and negative electrode coating portions 22 and 32 are disposed at an external side of the wound electrode assembly 10. Since the starting portions 22a and 32a include protrusions, locating the starting portions 22a and 32a at an external side of the wound electrode assembly 10 prevents the electrode assembly from having a non-uniform shape and prevents the electrode assembly from having an increased length and volume. Moreover, damage to the separator and any internal shortage between the positive and negative electrode plates may be prevented, thereby enhancing electric stability.

The location of the finishing portions 22b and 32b of the positive and negative electrode coating portions 22 and 32 is not limited to what is described above. Moreover, the wound ends of the positive electrode plate 20, negative electrode plate 30 and separator 40 are not limited to what is described above, but may be variously formed in the process of forming the electrode assembly.

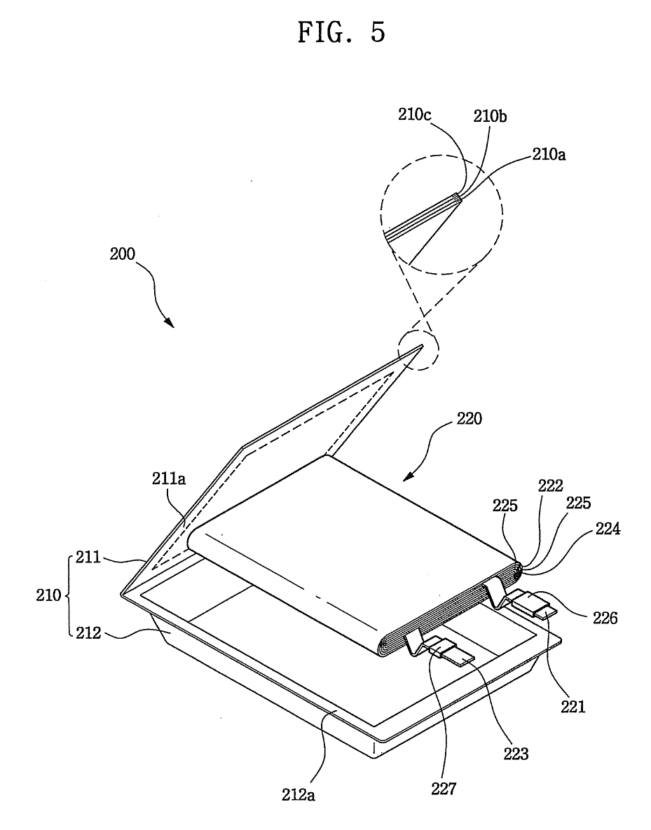

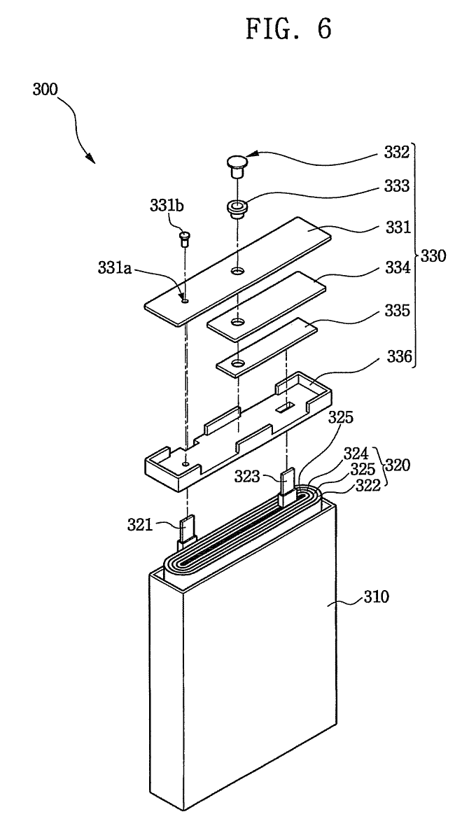

FIGS. 5 and 6 are exploded perspective views illustrating a pouch type and can type secondary battery, respectively, having the electrode assembly according to an embodiment of the present. Referring to FIG. 5, a pouch type secondary battery 200 may comprise a pouch-type casing 210 having an upper casing 211 and a lower casing 212, and an electrode assembly 220 contained in the pouch-type casing 210. An edge surface of the upper casing 211 is joined to an edge surface of the lower casing 212, and the other surfaces of the upper casing 211 and the lower casing 212 are spaced apart so as to contain the electrode assembly 220, therein.

Further, either the upper casing 211 or the lower casing 212 may have a space containing the electrode assembly 220. In the exemplary embodiment of the present invention, the space is illustrated as being formed in the lower casing 212.

An upper sealing portion 211a and lower sealing portion 212a that are sealed by heat-melting may be formed along borders of both the upper casing 211 and the lower casing 212, respectively.

The pouch-type casing 210 may have a multi-layered structure having a heat-melting layer 210a that provides sealing, a metal layer 210b that maintains mechanical strength and serves as a barrier to both oxygen and hydrogen, and an insulating layer 210c.

The electrode assembly 220 is formed by winding a first electrode plate 222 having a first electrode tab 221, a second electrode plate 224 having a second electrode tab 223, and a separator 225 interposed between the first and second electrode plates 222 and 224.

The electrode assembly 220 has a configuration illustrated in FIGS. 1A through 4, so a detailed description is not repeated here. Moreover, adhesive tap tapes 226 and 227 are disposed at an overlapping portion of the upper and lower sealing portions 211a and 212a of the first electrode tab 221 and the second electrode tab 223, respectively.

Referring to FIG. 6, a can type secondary battery 300 comprises a casing 310, a jelly-roll type electrode assembly 320 contained in the casing 310 and a cap assembly 330 connected to a side of the casing 310. The casing 310 is formed of a metal and may have a shape of a cylinder, prism, or bar having curved edges.

The electrode assembly 320 is formed by winding a first electrode plate 322 having a first electrode tab 321, a second electrode plate 324 having a second electrode tab 323, and a separator 325 interposed between the first and second electrode plates 322 and 324. The electrode assembly 320 has configuration illustrated in FIGS. 1A through 4, so a detailed description is not repeated here.

The cap assembly 330 comprises a cap plate 331 that seals an opening portion of the casing 310, an electrode terminal 332, a gasket 333 interposed between the electrode terminal 332 and the cap plate 331, an insulating plate 334, a terminal plate 335 and an insulating case 336. Further, the electrode terminal 332 is electrically connected to the terminal plate 335 disposed under the cap plate 331. The insulating plate 334 is disposed between the cap plate 331 and the terminal plate 335 to insulate the cap plate 331 and the terminal plate 335. An electrolyte inlet 331a through which electrolyte is injected is formed at a side of the cap plate 331. An electrolyte inlet cap 331b may be used to seal the electrolyte unit 331a.

The insulating case 336 is provided on the top of the electrode assembly 320 to prevent any movement of the electrode assembly 320. The first electrode tab 321 electrically connected to the first electrode plate 322 is welded on a bottom surface of the cap plate 331. Further, the second electrode tab 323 electrically connected to the second electrode plate 324 is welded on a bottom surface of the terminal plate 335.

The secondary batteries illustrated in FIGS. 5 and 6 may further comprise a protection circuit board mounting a protecting device for preventing any over-current flow, spark or security problem and so on.

Further, tubing or labeling may be further used on the external side of the secondary battery to protect the exterior of the secondary battery. Alternatively, a separate external case may be provided by combining at an external side of the secondary battery.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electrode assembly comprising:
a positive electrode plate having a positive electrode collector and a positive electrode coating portion formed on the positive electrode collector;
a negative electrode plate having a negative electrode collector and a negative electrode coating portion formed on the negative electrode collector; and
a separator,
wherein the positive electrode coating portion and/or the negative electrode coating portion is divided into a coating-starting portion, a coating-finishing portion and a uniform region between the coating-starting portion and the coating-finishing portion;
wherein the electrode assembly is wound into a jelly roll structure; and
wherein the coating-finishing portion is disposed at a center of the jelly-roll structure.

2. The electrode assembly of claim 1, wherein the coating-starting portion is thicker than the uniform region.

3. The electrode assembly of claim 1, wherein the coating-finishing portion is thinner than the uniform region.

4. The electrode assembly of claim 1, wherein the coating-starting portion is located at an outer portion of the jelly-roll structure.

5. The electrode assembly of claim 1, wherein the positive electrode collector is two-sided and the positive electrode coating portion is formed on both sides of the positive electrode collector and wherein the negative collector is two-sided and the negative electrode coating portion is formed on both sides of the negative electrode collector.

6. The electrode assembly of claim 5, wherein a direction from the coating-starting portion to coating-finishing portion of the positive electrode coating portion is the same on both sides of the positive electrode collector and a direction from the coating-starting portion to the coating-finishing portion of the negative electrode coating portion is the same on both sides of the negative electrode collector.

7. The electrode assembly of claim 1, wherein the positive electrode plate comprises a positive electrode non-coated portion to which a positive electrode tab is connected, and the negative electrode plate comprises a negative electrode non-coated portion to which a negative electrode tab is connected.

8. The electrode assembly of claim 1, wherein the positive electrode plate further comprises an insulating member that covers either the coating-starting portion or coating-finishing portion of the positive electrode coating portion and the negative electrode plate further comprises an insulating member that covers either the coating-starting portion or coating-finishing portion of the negative electrode coating portion.

9. A secondary battery comprising:
a casing; and
an electrode assembly wound into a jelly-roll structure and disposed inside the casing,
wherein the electrode assembly comprises a positive electrode plate having a positive electrode collector and a positive electrode coating portion formed on the positive electrode collector, a negative electrode plate having a negative electrode collector and a negative electrode coating portion formed on the negative electrode collector, and a separator,
wherein either the positive electrode coating portion or the negative electrode coating portion is divided into a coating-starting portion, a coating-finishing portion and a uniform region between the coating-starting portion and the coating-finishing portion; and
wherein the coating-finishing portion is disposed at a center of the jelly-roll structure.

10. The secondary battery of claim 9, wherein the casing is formed as cylinder, prism, or bar type having a curved edge.

11. The secondary battery of claim 10, wherein the casing is formed to have an opening portion at a side.

12. The secondary battery of claim 11, wherein the casing further comprises a cap assembly on the opening portion.

13. The secondary battery of claim 9, wherein the casing is a pouch type.

14. The secondary battery of claim 9, wherein the coating-starting portion is thicker than the uniform region.

15. The secondary battery of claim 9, wherein the coating-finishing portion is thinner than the uniform region.

16. The secondary battery of claim 9, wherein the coating-starting portion is located at an outer portion of the jelly-roll structure.

17. The secondary battery of claim 9, wherein the positive electrode collector is two-sided and the positive electrode coating portion is formed on both sides of the positive electrode collector and wherein the negative electrode collector is two-sided and the negative electrode coating portion is formed on both sides of the negative electrode collector..

18. The secondary battery of claim 17, wherein a direction from the coating-starting portion to the coating-finishing portion of the positive electrode coating portion is the same on both sides of the positive electrode collector and a direction from the coating-starting portion to the coating finishing portion of the negative electrode coating portion is the same on both sides of the negative electrode collector.

19. The secondary battery of claim 9, wherein the positive electrode plate and the negative electrode plate respectively comprise a positive non-coating portion to which a positive electrode tab is joined and a negative non-coating portion to which a negative electrode tab is joined.

20. The secondary battery of claim 9, wherein the positive electrode plate and the negative electrode plate respectively further comprise an insulating member covering either the coating-starting portion or the coating-finishing portion.
